(19) United States
(12) Patent Application Publication
(10) Pub. No.: US 2009/0026914 A1
(43) Pub. Date: Jan. 29, 2009

(54) ELECTRON-EMITTING DEVICE, ELECTRON SOURCE, IMAGE DISPLAY APPARATUS, AND INFORMATION DISPLAY REPRODUCING APPARATUS

(75) Inventors: Kazushi Nomura, Sagamihara-shi (JP); Ryoji Fujiwara, Chigasaki-shi (JP); Michiyo Nishimura, Sagamihara-shi (JP); Yoji Teramoto, Ebina-shi (JP); Shunsuke Murakami, Atsugi-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/173,988

(22) Filed: Jul. 16, 2008

(30) Foreign Application Priority Data
Jul. 25, 2007 (JP) 2007-193165

(51) Int. Cl. H01J 1/54

(52) U.S. Cl. 313/498

(57) ABSTRACT

To provide an electron-emitting device having an electron-emitting film containing a metal and a carbon, wherein a density of the electron-emitting film other than the metal is determined to be not less than 1.2 g/cm³ and not more than 1.8 g/cm³, and a hydrogen content in the electron-emitting film is determined to be not less than 15 atm % and not more than 40 atm % with respect to the all atoms composing the electron-emitting film. Further, a concentration of the metal in the range of a depth from a surface of this electron-emitting film up to 10 nm is determined to be not less than 0.1 atm % and not more than 40 atm % with respect to number of carbon atoms contained in the electron-emitting film.

### BACKGROUND OF THE INVENTION

1. Field of the Invention

The present invention relates to an electron-emitting device having an electron-emitting film. Particularly, the present invention is preferably applied to an electron source used for a television set, a display of computer, and an electron beam drawing apparatus or the like, an image display apparatus, and an image reception display apparatus.

2. Description of the Related Art

Conventionally, as a surface conduction electron-emitting device, a device in which a thin film has an electron-emitting portion and the thin film has an amorphous carbon and a conducting fine particle has been known (Japanese Patent Application laid-Open No. 8-55563). This electron-emitting portion described in JP-A No. 8-55563 is an amorphous carbon and has a conductive particle in a thin film portion.

In addition, in a field of an FPD (flat panel display), low power consumption, a high definition, and a high brightness have been expected.

As a result, as an electron-emitting material, one that can obtain a desired density of emitted electrons in an electric field, which is low as much as possible, has been required. In addition, as an electron-emitting material, one having a high uniformity of a shape has been required.

### SUMMARY OF THE INVENTION

An object of the present invention is to provide an electron-emitting device, which has a substantially-flat electron-emitting film and can obtain a high density of emission current in a low electric field, and an apparatus having this electron-emitting device.

In order to attain the above-described object, the present invention provides an electron-emitting device having an electron-emitting film containing a metal and a carbon, wherein a density of the electron-emitting film other than the metal is not less than 1.2 g/cm³ and not more than 1.8 g/cm³, and a hydrogen content in the electron-emitting film is not less than 15 atm % and not more than 40 atm % with respect to the all atoms composing the electron-emitting film.

According to this invention, it is possible to provide an electron-emitting device, which can obtain a high density of emission current in a low electric field. Therefore, a drive voltage can be lowered and a power of consumption can be also reduced. In addition, a high definition in the same display measurement can be realized. Compared to the case that a measurement of a pixel is small, a density of emission current can be heightened. Therefore, this invention can be used as an electron-emitting device which can provide a panel having a high brightness.

Further features of the present invention will become apparent from the following description of exemplary embodiments with reference to the attached drawings.

### BRIEF DESCRIPTION OF THE DRAWINGS

FIG. 1 is a cross sectional view showing an electron-emitting film according to an embodiment of the present invention;

FIG. 2A and FIG. 2B are cross sectional views for explaining a method of manufacturing the electron-emitting film according to the embodiment of the present invention;

FIG. 3 is a block diagram showing a structure of an image display apparatus according to the embodiment of the present invention;

FIG. 4 is a schematic diagram showing a structure of a phosphor film of the image display apparatus according to the embodiment of the present invention;

FIG. 5 is a view showing a schematic structure of an image reception display apparatus using an electron-emitting device according to the embodiment of the present invention;

FIG. 6 is a schematic diagram for explaining an evaluation method when evaluating an electron emission characteristic of an electron-emitting film according to a first example of the present invention;

FIG. 7A and FIG. 7B are cross sectional views for explaining a method of manufacturing the electron-emitting film according to a second example of the present invention; and

FIG. 8A and FIG. 8B are cross sectional views for explaining a method of manufacturing the electron-emitting film according to a third example of the present invention.

### DESCRIPTION OF THE EMBODIMENTS

Hereinafter, the embodiments of the present invention will be described with reference to the drawings. In the all drawings of the following embodiments, the same or the corresponding parts are provided with the same reference numerals. In addition, the scope of this invention is not limited to the measurement, the material, the shape, and the relative arrangement or the like of the constituent parts described in these embodiments unless it is particularly described.

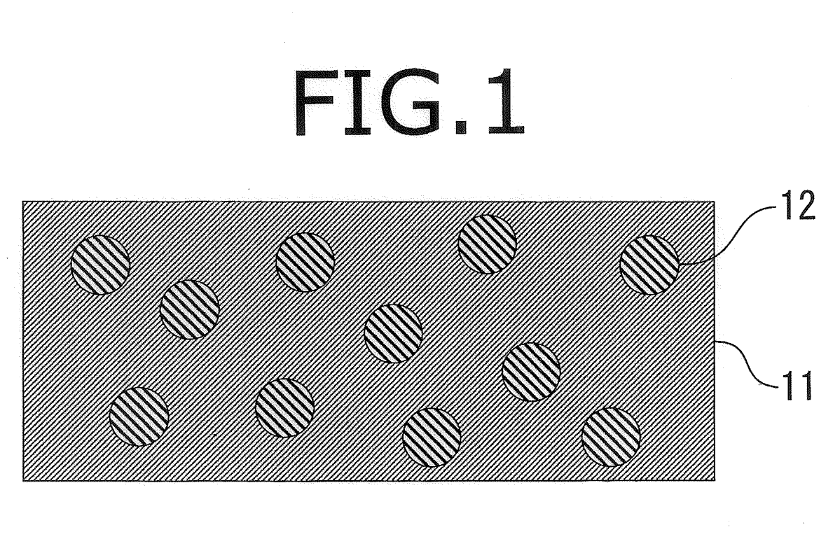

Hereinafter, the embodiment, which is the premise of this invention, will be described with reference to the drawings. FIG. 1 shows an electron-emitting film according to this embodiment. As shown in FIG. 1, in the electron-emitting film according to this embodiment, a metal particle 12 is dispersed on an amorphous carbon layer 11 made of a hydrogen-containing amorphous carbon.

In addition, the electron-emitting device according to this embodiment is an electron-emitting device provided with an electron-emitting film containing a metal and a carbon. The density of the electron-emitting film other than this metal is not less than 1.2 cm³ and not more than 1.8 g/cm³. Hydrogen content in the electron-emitting film is not less than 15 atm % and not more than 40 atm % with respect to the all atoms composing the electron-emitting film.

In addition, concentration of a metal in the range of a depth from the surface of this electron-emitting film up to 10 nm is not less than 0.1 atm % and not more than 40 atm % with respect to number of carbon atoms contained in the electron-emitting film. Further, any concentration may be available with respect to the concentration of a metal in the range from the surface of this electron-emitting film over 10 nm and it is not particularly limited. In addition, the shape of the electron-emitting film according to this embodiment is substantially flat. Specifically, an Rms (root mean square of surface roughness) on the surface of the electron-emitting film, on which electrons are emitted, is not more than 10 nm.

In addition, it is considered that conduction of the electron in the electron-emitting film, which is formed in the electron-emitting device according to this embodiment, is carried out depending on a metal and a carbon. Further, it is considered that emission of electron from the electron-emitting film depends on a carbon, hydrogen, and a metal. Therefore, if the density of a carbon in the electron-emitting film is lowered, an electron conducting pass to the surface of the electron-emitting film as an electron-emitting portion is reduced, so that an electron emission characteristic is deteriorated. On the other hand, if the density of a carbon in the electron-emitting film is heightened, a crystallinity of a carbon is improved, so that the place where a carbon and hydrogen are connected is extremely made smaller. Thereby, it becomes difficult for a hybrid orbital effective for emission of electron to be shaped. Therefore, a sight where emission of electron is carried out is reduced, so that the electron emission characteristic is deteriorated.

Accordingly, it is preferable that the density of the electron-emitting film other than a metal in the electron-emitting film according to this embodiment is not less than 1.2 g/cm³ and not more than 1.8 g/cm³. Further, by making a hydrogen content (a hydrogen content) rate in the electron-emitting film not less than 15 atm % and not more than 40 atm %, it is possible to form an electron-emitting film, which can obtain a high density of emission current in a low electric field.

In addition, according to knowledge of the inventors of the present invention, it is preferable that a concentration of a metal in the vicinity of the surface of the electron-emitting film to function effectively for the electron-emitting device is not less than 0.1 atm % not more than 40 atm % with respect to the number of carbon atoms. It is considered that this is because that the concentration of a metal in the vicinity of the surface of the electron-emitting film is effective for the number of the electron-emitting portions. Here, it is defined that the vicinity of the surface of the electron-emitting film is the range of the depth that is measured by an X-ray photoelectron spectroscopy (XPS method), and for example, it is the range of the depth from the surface of the electron-emitting film up to 10 nm. In the area other than the vicinity of the surface of the electron-emitting film, namely, the area from the surface of the electron-emitting film up to the depth more than 10 nm, the concentration of a metal may be not more than 0.1 atm % or may be not less than 40 atm %.

In addition, the part other than a metal in the electron-emitting film provided to the electron-emitting device according to the present embodiment is mainly composed of a carbon and hydrogen. The part other than a metal in the electron-emitting film may contain an impurity such as nitrogen and oxygen by minute amounts for the quantity of carbon and hydrogen contained therein. The part other than a metal in the electron-emitting film may not contain the impurity of the same amounts of carbon and hydrogen or more. Further, the surface of the electron-emitting film is terminated with hydrogen (namely, a hydrogen termination). In other words, on the surface of the electron-emitting film, a hydrogen amorphous carbon (α-C:H) is composed. Further, a density of an electron-emitting film, the hydrogen content (the contained hydrogen amount of the electron-emitting film) and a concentration of a metal for carbon can be measured by an X-ray reflectivity technique, a Rutherford scatter spectroscopic method (RBS)/Hydrogen forward scattering (HFS), an X-ray photoelectron spectroscopy (XPS) and a secondary ion mass spectrometry (SIMS), which are popular.

### (Method of Manufacturing Electron-Emitting Layer)

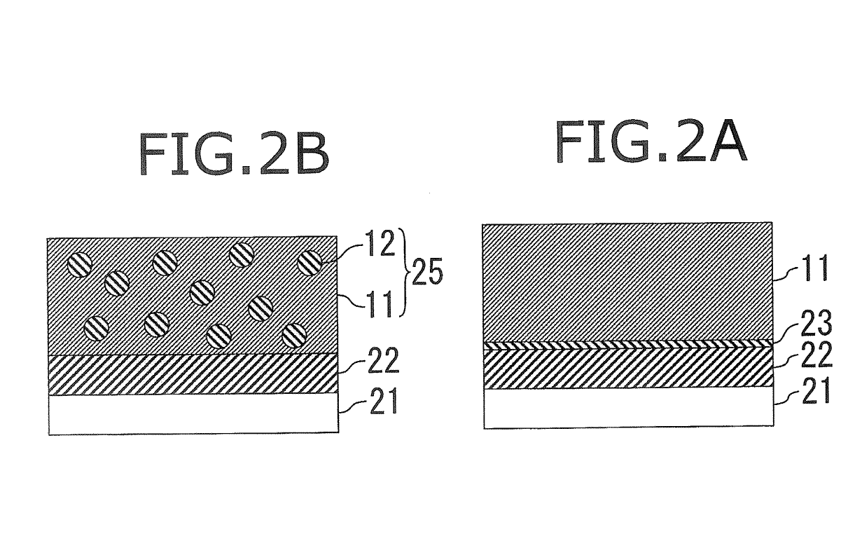

A method of manufacturing the electron-emitting film according to this embodiment described above will be explained below. As shown in FIG. 1, in the electron-emitting film according to this embodiment, metal particles 12 are included in the electron-emitting film being condensed to some extent. In addition, a method of manufacturing the electron-emitting film shown in FIG. 1 will be described with reference to FIG. 2A and FIG. 2B.

### (Step 1)

As shown in FIG. 2A, at first, on an insulating substrate 21, of which surface is sufficiently cleaned, a conducting layer 22, a metal thin film 23, and an amorphous carbon layer 11 are formed in series.

The insulating substrate 21 is arbitrarily selected from the followings, for example. The insulating substrate 21 is an insulating substrate made of, for example, a fused quarts glass, a glass having a contained amount of an impurity such as natrium (Na) reduced, a soda lime glass, a laminated body having oxide silicon (SiO₂) film laminated on a silicon (Si) substrate, or ceramics such as alumina (Al₂O₂).

The conducting layer 22 is formed by using a popular vacuum vapor deposition method such as a chemical vapor deposition (CVD) method, a vapor deposition method and a spattering method, or a printing technology. The material of the conducting layer 22 is selectively selected from a metal, an alloy material, carbide, a boride, a nitride, and a semiconductor. Specifically, examples of metal include beryllium (Be), magnesium (Mg), titan (Ti), zirconium (Zr), hafnium (Hf), vanadium (V), niobium (Nb), tantalum (Ta), molybdenum (Mo), tungsten (W), aluminum (Al), copper (Cu), nickel (Ni), chrome (Cr), gold (Au), platinum (Pt), and vanadium (Pd), and the alloy material includes these metals. Examples of carbide include titanium carbide (TiC), zirconium carbide (ZrC), hafnium carbide (HfC), tantalum carbide (TaC), silicon carbide (SiC) and tungsten carbide (WC). Examples of boride include hafnium boride (HfB₂), zirconium boride (ZrB₂), lanthanum boride (LaB₆) selenium boride (CeB₆), yttrium boride (YB₄), and gadolinium boride (GdB₄). Examples of nitride include titanium nitride (TiN) zirconium nitride (ZrN), and hafnium nitride (HfN). The semiconductor is Si and germanium (Ge) or the like. In addition, the film thickness of the conducting layer 22 is determined not less than 10 nm and not more than 10 μm, and preferably, the film thickness of the conducting layer 22 is selected from the range of not less than 10 nm and not more than 1 μm.

A metal thin film 23 is formed by a popular vacuum vapor deposition method such as various CVD methods, a vapor deposition method and a spattering method. The metal thin film 23 may be formed by the same method as the conducting layer 22 or may be formed by a method that is different from the conducting layer 22. In addition, the material of the metal thin film 23 may be the same material as the conducting layer 22 or may be formed by a material that is different from the conducting layer 22. Specifically, as a material of the metal thin film 23, a material that can be diffused on an amorphous carbon layer 11 may be arbitrarily selected. As a result, it is preferable that the material of the metal thin film 23 is arbitrarily selected from Co, Pt, and Ni. In addition, in the case of forming the metal thin film 23 from the same material as the conducting layer 22, it is also possible to use the conducting layer 22 as the metal thin film 23. In this case, a step for forming the metal thin film 23 can be omitted. In addition, the film thickness of the metal thin film 23 is selected from the range of not more than 1 μm and preferably, the film thickness of the metal thin film 23 is selected from the range of not more than 100 nm. In addition, the metal thin film 23 may be formed on the amorphous carbon layer 11 after the amorphous carbon layer 11 is laminated. In this case, the film thickness of the metal thin film 23 is selected from the range of not more than 10 nm, and preferably, the film thickness of the metal thin film 23 is selected from the range of not more than 1 nm.

The amorphous carbon layer 11 is formed by a popular vacuum vapor deposition method such as various CVD methods and a spattering method or a technology for decomposing an organic solvent by heating. The material for forming the amorphous carbon layer 11 is mainly a carbon and hydrogen, however, an element such as a nitride and an oxygen may be mixed by minute amounts. The film thickness of the amorphous carbon layer 11 is selected from the range of not more than 10 μm and preferably, the film thickness of the amorphous carbon layer 11 is selected from the range of not more than 1 μm.

### (Step 2)

Next, a heating treatment is carried out in an atmosphere containing a hydrocarbon gas. Thereby, as shown in FIG. 2B, metal particles 12 are contained in the amorphous carbon layer 11. In other words, the electron-emitting film according to the present embodiment is formed. Further, a hydrocarbon gas may be contained in at least a partial time of a time for carrying out a heating treatment. In other words, the atmosphere in the step of this heating treatment may be made into an atmosphere containing a hydrocarbon gas continuously or may be made into an atmosphere containing a hydrocarbon gas only for a partial time of the step.

The material of the hydrocarbon gas is arbitrarily selected from CH₄, C₂H₂, C₂H₄, C₂H₆, C₃H₆, and C₇H₈ or the like. In addition, the atmosphere containing the hydrocarbon gas may be only a hydrocarbon gas or may be a mixture gas in which a hydrocarbon is mixed with H₂, N₂, Ar, and He or the like. A quality of the amorphous carbon layer 11 in the step 2 may be different from a quality of the amorphous carbon layer 11 in the step 1 or may be the same as this.

In this step 2, atoms of the metal thin film 23 as the metal particles 12 are diffused in the amorphous carbon layer 11. Further, the metal particle 12 may be an aggregate of the atom of the metal thin film 23, and this aggregate may be diffused.

Thus, the electron-emitting film according to the present embodiment is formed. Then, by providing this electron-emitting film, an electron source such as an electron gun and various devices for carrying out emission of an electron such as an electron-emitting device can be formed.

### (Electron-Emitting Layer)

Next, an application of an electron-emitting film according to the above-described embodiment will be described. By using the electron-emitting film according to this embodiment being combined with an extraction electrode or the like, for example, an electron-emitting device can be formed. Further, by aligning a plurality of these electron-emitting devices on the substrate, for example, an electron source and an image display apparatus can be formed.

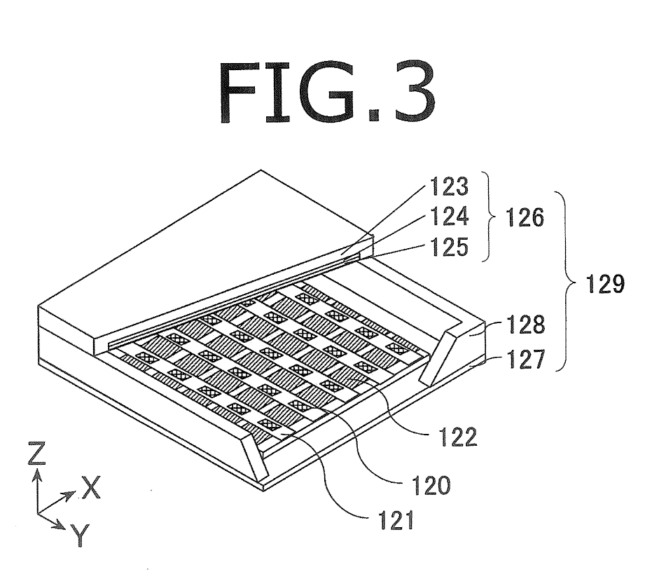

Next, an image display apparatus as a display unit, which is formed by using an electron-emitting device having an electron-emitting film according to this embodiment will be described. FIG. 3 shows the image display apparatus according to this embodiment.

As shown in FIG. 3, the image display apparatus has an electron-emitting device 120 according to the present embodiment. This electron-emitting device 120 is connected to an extraction electrode 121. In addition, in this image display apparatus, a face plate 126 and a container 129 are provided. This face plate 126 is formed by a glass substrate 123, a phosphor film 124, and a metal back 125. Then, the container 129 is formed by this face plate 126, a base frame 128, and an electron source substrate 127. Further, this electron source substrate 127 is formed by arranging a plurality of electron-emitting devices 120 for emitting an electron.

The extraction electrode 121 and an anode electrode 122 may be made into a wiring in a row direction and a wiring in a column direction, respectively. Further, a wiring in a row direction and a wiring in a column direction may be connected to the extraction electrode 121 and the anode electrode 122, respectively.

The face plate 126 is bonded to the base frame 128 by using a flit glass of a low fusing point or the like. At least one support body such as a spacer (not illustrated) may be set between the face plate 126 and the electron source substrate 127. By providing this support body (spacer), it is possible to form the container 129 having a sufficient strength against an atmospheric pressure.

The image display apparatus is formed by the electron-emitting device 120 that is arranged on the electron source substrate 127 in a matrix, the extraction electrode 121, the anode electrode 122, and the container 129.

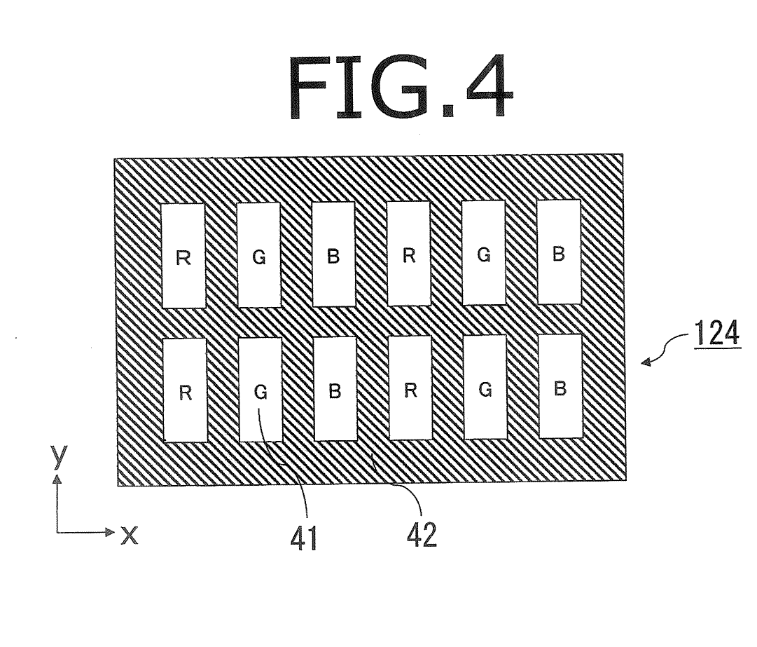

FIG. 4 schematically shows a part of the structure of the phosphor film 124. As shown in FIG. 4, this phosphor film 124 is formed by a phosphor 41 as a light-emitting member and a light-absorbing member 42. The phosphors 41 are regularly arranged in response to an emission color to be displayed. Specifically, the phosphors 41 are arranged in an x direction (lateral direction) in the order of R (red), G (green), and B (blue), and the phosphors 41 of the same color are arranged in a y direction (longitudinal direction). Then, by flashing a necessary phosphor 41 among these phosphors 41, an image displayed on the outer face of the glass substrate 123.

In addition, these phosphors 41 are partitioned by the light-absorbing member 42 each other. By providing this light-absorbing member 42, inhibiting a color mixture of three primary colors necessary for displaying a color at each phosphor 41, it is possible to inhibit lowering of a contrast.

### (Image Reception Display Apparatus)

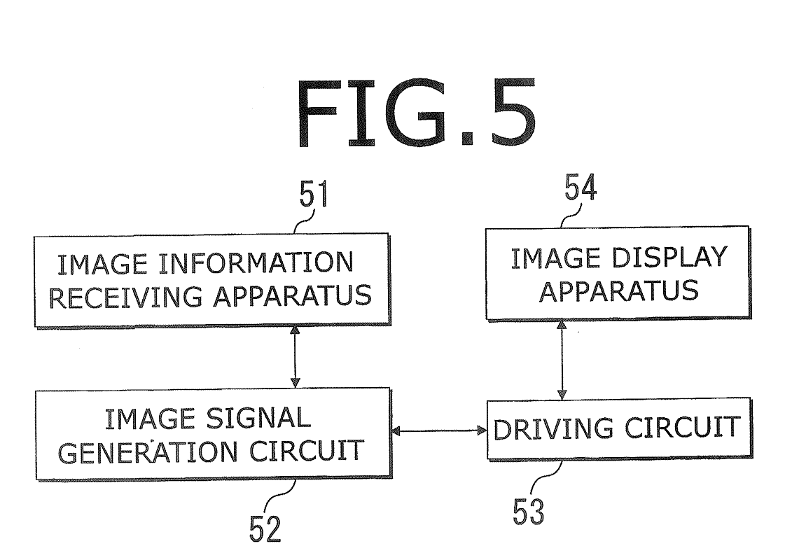

Next, an image reception display apparatus according to the embodiment of the present invention as an information display reproducing apparatus will be described. FIG. 5 shows the image reception display apparatus according to the present embodiment. Further, the image reception display apparatus according to the present embodiment is provided with the image display apparatus shown in FIG. 3.

As shown in FIG. 5, the image reception display apparatus according to the present embodiment has an image information receiving apparatus 51 as a receiver for receiving a broadcast signal, an image signal generation circuit 52, a driving circuit 53, and an image display apparatus 54 having an electron-emitting device.

Then, signals (image information signals) of image information, character information, and sound information, which are received by the image information receiving apparatus 51, are supplied to the image signal generation circuit 52. The image signal generation circuit 52 generates an image signal from the supplied image information signal and outputs it. For example, the image information receiving apparatus 51 is a receiver such as a tuner, which can select a channel of image broadcasting or the like via a radio broadcast, a cable broadcast, and Internet and can receive the image information signal of these broadcastings.

The image signal generation circuit 52 generates an image signal corresponding to each pixel of an image display apparatus 54 from the image information. The generated image signal is supplied to the driving circuit 53. The driving circuit 53 controls an applied voltage for the image display apparatus 54 on the basis of the inputted image signal. Thereby, an image is displayed on the image display apparatus 54. Thus, the image reception display apparatus according to the present embodiment is formed to be operated.

### FIRST EXAMPLE

Next, the first example on the basis of the above-described embodiment will be described. A structure of the electron-emitting film and a method of manufacturing the electron-emitting film according to the present example are equal to those of the above-described embodiment (same as FIG. 1, FIG. 2A, and FIG. 2B). Hereinafter, with respect to the electron-emitting film according to this first example will be specifically described.

### (Step 1)

At first, as shown in FIG. 2A, by evaporating a TiN film on the insulating substrate 21 made of a quarts substrate, of which surface is sufficiently cleaned by using a vacuum vapor deposition method, the conducting layer 22 is formed. In this first example, the film thickness of the conducting layer 22 is defined to be 200 nm.

Next, by laminating Pt on the conducting layer 22 by using a spattering method, the metal thin film 23 is formed. The film thickness of this metal thin film 23 is defined to be 20 nm. Next, by vapor-depositing an amorphous carbon on the metal thin film 23 by using a micro wave CVD method, the amorphous carbon layer 11 is formed. In this first example, the film thickness of the amorphous carbon layer 11 is defined to be 30 nm. The amorphous carbon layer 11 is formed under the condition (condition of formation) that a gas to be used is a hydrocarbon gas (CH₄:H₂=1:1), a temperature of the substrate is 450° C., an atmosphere pressure is 100 Torr (1.33×10⁴ Pa), and an applied voltage is 150 W.

### (Step 2)

Next, a heating treatment has been carried out for five hours under the condition that an atmosphere (hydrocarbon gas atmosphere) is C₂H₂:1% H₂/99% Ar=1:1, an atmospnere pressure is 10 Torr (1.33×10³ Pa), and a temperature of the substrate is 550° C. Thereby, as shown in FIG. 2B, Pt is heat-diffused in the amorphous carbon layer 11 and an electron-emitting film 25 is formed as the amorphous carbon layer 11 containing the metal particle 12. Further, the metal particle 12 is an aggregation ball of Pt and these aggregation balls are dispersed in the amorphous carbon layer 11.

The part made of an amorphous carbon of the electron-emitting film 25 according to this first example is measured by RBS/HFS. As a result, a hydrogen content is 35 atm %. In addition, in the electron-emitting film 25 according to this first example, a density of a film of the amorphous carbon part other than the metal particle is 1.2 g/cm³ from a result of measurement of an X-ray reflection rate and a measurement result of a ratio of the contained element by XPS. The concentration of Pt in the vicinity of the surface of the electron-emitting film 25 according to this first example is 0.1 atm % from the measurement result of the ratio of the contained element by XPS.

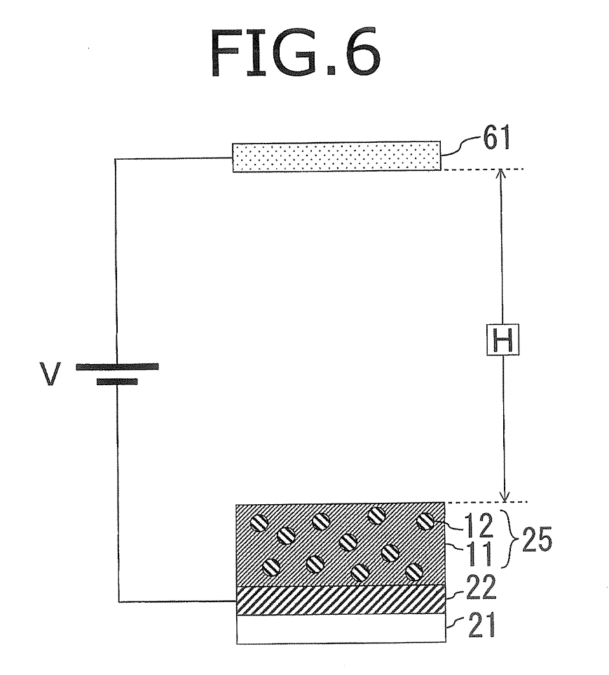

An electron emission characteristic of the electron-emitting film 25 according to the present example is measured. FIG. 6 shows a pattern diagram of the measurement method.

As shown in FIG. 6, an anode electrode 61 on the position distanced by a distance H from the electron-emitting film 25 is located, and a predetermined voltage V between the anode electrode 61 and the conducting layer 22 is applied so that an electron emission characteristic is measured. The anode electrode 61 is formed by laminating a transparent conducting thin film (ITO, Indium Tin Oxide) and a thin film phosphor layer in series on fusing quarts glass allowing a visible light to pass there through. This anode electrode 61 is formed so as to be capable of observing a light-emitting image through the fusing quarts glass. In this first example, H is about 100 μm and an applied voltage is 0 to 5 kV.

In addition, or comparison, by changing a film formation condition of the electron-emitting film, an electron-emitting film for comparison, in which a density of the part other than a metal is 1.1 g/cm³, is formed. Then, the electron emission characteristic of the electron-emitting film for comparison is measured in the same way. As a result, it is confirmed that a luminescent point of the electron-emitting film 25 according to this first example is improved by about 1,000 times as much as the electron-emitting film for comparison. In other words, an effect equivalent to the effect that the electron-emitting portion is made about 1,000 times as large is obtained. With respect to the electron-emitting film for comparison, the electron emission is not stable. Further, it is confirmed that some electron-emitting films for comparison do not emit an electron after applying a voltage due to discharge.

### SECOND EXAMPLE

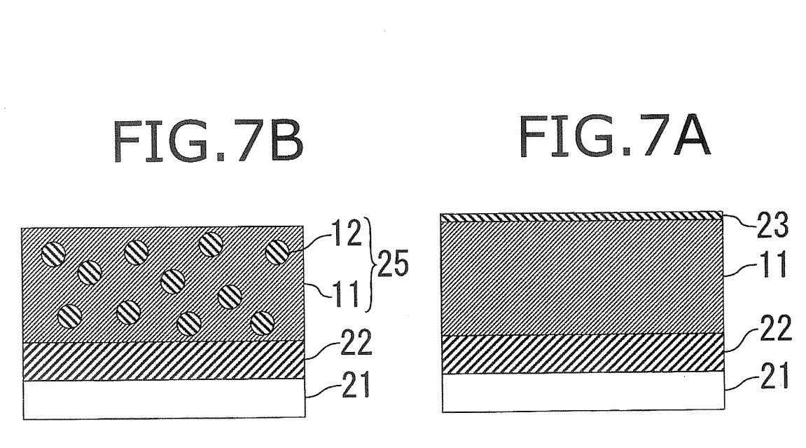

Next, a second example on the basis of the above-described embodiment will be described. Further, wish respect to the same structure as the first example, the explanation thereof is herein omitted. FIG. 7A and FIG. 7B show a method of manufacturing an electron source according to this second example.

### (Step 1)

At first, as shown in FIG. 7A, the conducting layer 22 is formed by vapor-depositing a titanium nitride (TiN) on the insulating substrate 21, of which surface has been sufficiently cleaned in advance, made of a quarts substrate, for example, by using a vacuum vapor deposition method. In this second example, the film thickness of the conducting layer 22 is defined to be 200 nm. Next, by using the micro wave CVD method, the amorphous carbon layer 11 is formed on the conducting layer 22. In second example, the film thickness of the amorphous carbon layer 11 is defined to be 50 nm. The amorphous carbon layer 11 is formed under the condition that the atmosphere gas (hydrocarbon gas) is acetylene (C₂H₂):hydrogen(H₂)=3:1 and the atmosphere pressure is 100 Torr (1.33×10⁴ Pa). In addition, a micro wave power is determined to be 200 W, a temperature of a substrate is determined to be 800° C., and a substrate bias is determined to be −200 V. After that, as a metal thin film, a cobalt (Co) having a film thickness about 3 nm is formed on the amorphous carbon layer 11 by using a spattering method.

### (Step 2)

Next, in vacuum having a pressure of 10⁻⁶ Torr (1.33×10⁻⁴ Pa), a temperature of a substrate is set at 650° C. and a heating treatment is carried out for four hours so that Co is heat-diffused in the amorphous carbon layer 11. Consequently, by carrying out the heating treatment for 30 minutes, as shown in FIG. 7B, the electron-emitting film 25 is formed as the amorphous carbon layer 11 containing the metal particle 12. This heating treatment is carried out under the condition that the atmosphere gas is a methane gas (CH₄), a pressure is 50 Torr (6.67×10⁻³ Pa), and a temperature of a substrate is set at 650° C. Further, the metal particle 12 is an aggregation ball of Co, and these aggregation balls are dispersed in the amorphous carbon layer 11.

The hydrogen content of the part made of an amorphous carbon (other than a metal) of the electron-emitting film 25 according to this second example is 25 atm %. In the electron-emitting film 25 according to this second example, the density of the film of the amorphous carbon part other than a metal particle is 1.8 g/cm³. The concentration of Co in the vicinity of the surface of the electron-emitting film 25 according to the second example is 40 atm %.

In addition, for comparison, by changing the condition for film formation of the electron-emitting film 25, an electron-emitting film for comparison that the density of the part other than the metal is 1.9 g/cm³ is formed. Then, the electron-emitting film for comparison is measured in the same way. As a result, it is confirmed that a luminescent point of the electron-emitting film 25 according to this second example is improved by about 100 times as much as the electron-emitting film for comparison. In other words, an effect equivalent to the effect that the electron-emitting portion is made about 100 times as large is obtained.

### THIRD EXAMPLE

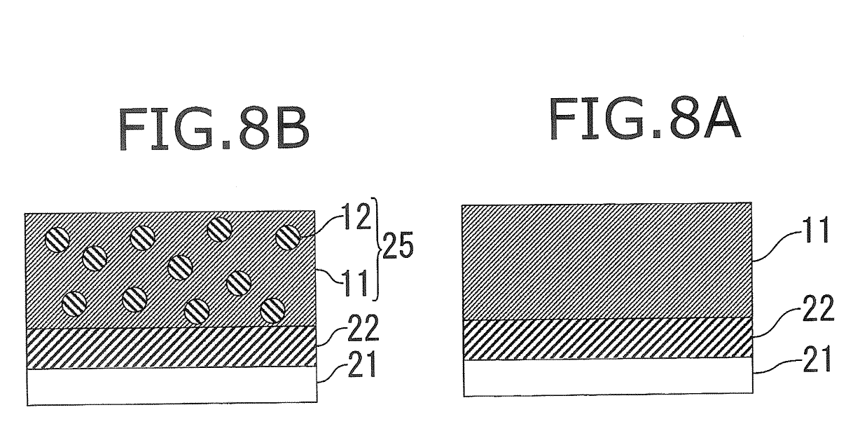

Next, a third example on the basis of the above-described embodiment will be described. Further, with respect to the same structure as the first example and the second example, the explanation thereof is herein omitted. FIG. 8A and FIG. 8B show a method of manufacturing an electron source according to this third example.

### (Step 1)

At first, as shown in FIG. 8A, the conducting layer 22 is formed by vapor-depositing platinum (Pt) on the insulating substrate 21, of which surface has been sufficiently cleaned in advance, made of a quarts substrate by using a vacuum vapor deposition method. In this third example, the film thickness of the conducting layer 22 is defined to be 200 nm. Next, by using a micro wave CVD method, the amorphous carbon layer 11 is formed on the conducting layer 22. In this third example, the film thickness of the amorphous carbon layer 11 is defined to be 30 nm. In addition, the amorphous carbon layer 11 is formed under the condition that the atmosphere gas (hydrocarbon gas) is acetylene (C₂H₂):hydrogen(H₂)=1:1 and the atmosphere pressure is 5 Torr (6.67×10² Pa). In addition, a micro wave power is determined to be 200 W, a temperature of a substrate is determined to be 800° C., and a substrate bias is determined to be −200 V.

### (Step 2)

Next, a heating treatment has been carried out for 8 hours under the condition that an atmosphere gas (hydrocarbon gas) is methane (CH₄):hydrogen (H₂)=1:1, an atmosphere pressure is 100 Torr (1.33×10⁴ Pa), and a temperature of the substrate is 650° C. Thereby, as shown in FIG. 8B, Pt is heat-diffused in the amorphous carbon layer 11 and the electron-emitting film 25 is formed as the amorphous carbon layer 11 containing the metal particle 12. Further, the metal particle 12 is an aggregation ball of Pt and these aggregation balls are dispersed in the amorphous carbon layer 11.

The hydrogen content of the part made of an amorphous carbon (other than a metal) of the electron-emitting film 25 according to this third example is 15 atm %. In the electron-emitting film 25 according to this third example, the density of the film of the amorphous carbon part other than a metal particle is 1.7 g/cm³. The concentration of platinum (Pt) in the vicinity of the surface of the electron-emitting film 25 according to this third example is 3 atm %.

In addition, for comparison, by changing the condition for film formation of the electron-emitting film 25, an electron-emitting film for comparison that the hydrogen content of the amorphous carbon part is 10 atm % is formed. Then, the electron emission characteristic of the electron-emitting film for comparison is measured in the same way. As a result, it is confirmed that a luminescent point of the electron-emitting film 25 according to this third example is improved by about 100 times as much as the electron-emitting film for comparison. In other words, an effect equivalent to the effect that the electron-emitting portion is made about 100 times as large is obtained.

### FOURTH EXAMPLE

Next, a forth example on the basis of the above-described embodiment will be described. Further, with respect to the same structure as the first to third examples, the explanation thereof is herein omitted. In addition, a method of manufacturing an electron source according to this forth example is the same as the second example (FIG. 7A and FIG. 7B)

### (Step 1)

At first, as shown in FIG. 7A, the conducting layer 22 is formed by vapor-depositing tungsten (W) on the insulating substrate 21, of which surface has been sufficiently cleaned in advance, made of a quarts substrate by using a vacuum vapor deposition method. In this fourth example, the film thickness of the conducting layer 22 is defined to be 300 nm. Next, by using an RF plasma CVD method, the amorphous carbon layer 11 is formed on the conducting layer 22. In this fourth example, the film thickness of the amorphous carbon layer 11 is defined to be 80 nm. The amorphous carbon layer 11 is formed under the condition that the atmosphere gas is a methane gas (CH₄) and the atmosphere pressure is 100 m Torr (13.3 Pa). In addition, an RF power is determined to be 400 W, an RF frequency is 13.56 MHz, a temperature of a substrate is determined to be 450° C., and a substrate bias is determined to be −200 V. After that, as a metal thin film, a nickel (Ni) having a film thickness 3 nm is formed on the amorphous carbon layer 11 by using a spattering method.

### (Step 2)

Next, in vacuum having a pressure of 10⁻⁶ Torr (1.33×10⁻⁴ Pa), a temperature of a substrate is set at 650° C. and a heating treatment is carried out for five hours so that Ni is heat-diffused in the amorphous carbon layer 11. Consequently, by carrying out the heating treatment in the hydrocarbon gas atmosphere of acetylene (C₂H₂):1% H₂/99% Ar=1:1, Ni in the amorphous carbon layer 11 is aggregated (FIG. 7B). This heating treatment is carried out under the condition that a temperature of a substrate is set at 650° C. and a heating time is 30 minutes. Thereby, the aggregation balls of Ni are dispersed as a metal particle in the amorphous carbon layer 11.

The hydrogen content of the amorphous carbon part of the electron-emitting film 25 according to this fourth example is 40 atm %. In the electron-emitting film 25 according to this forth example, the density of the film of the amorphous carbon part other than a metal particle is 1.3 g/cm³. The concentration of nickel (Ni) in the vicinity of the surface of the electron-emitting film 25 according to this forth example is 10 atm %.

In addition, for comparison, by changing the condition for film formation of the electron-emitting film 25, an electron-emitting film for comparison that the hydrogen content of the amorphous carbon part is not less than 40 atm % and not more than 45 atm % is formed. Then, the electron emission characteristic of the electron-emitting film for comparison is measured in the same way. As a result, it is confirmed that a luminescent point of the electron-emitting film 25 according to this fourth example is improved by about 100 times as much as the electron-emitting film for comparison. In other words, an effect equivalent to the effect that the electron-emitting portion is made about 100 times as large is obtained.

### FIFTH EXAMPLE

Next, the device according to the above-described first to fourth examples will be described. In other words, an electron-emitting device (not illustrated) is formed by using the electron-emitting film 25 according to the above-described first to fourth examples. Then, these electron-emitting devices are arranged, for example, in a matrix of 720×160, and the container 129 as shown in FIG. 3 is formed. Further, by using this, an image display apparatus is manufactured. As a result, the image display apparatus, which has a high definition and can realize matrix display, is manufactured.

As described above, the embodiments and the examples of the present invention are specifically described. However, the present invention is not limited to the above-described embodiments. The present invention can be variously modified on the basis of the technical idea. For example, numeric values and the constituent elements cited in the above-described embodiments are merely an example. According to need, the numeric values and the constituent elements, which are different from above, may be used.

For example, in the above-described embodiments, by connecting an acoustic device (not illustrated) to the image information receiving apparatus 51, a television set having the image signal generation circuit 52, the driving circuit 53, and the image display apparatus 54 can be also composed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-193165, filed on Jul. 25, 2007, which is hereby incorporated by reference herein in its entirety.

What is claimed is:

1. An electron-emitting device having an electron-emitting film containing a metal and a carbon,
wherein a density of the electron-emitting film other than the metal is not less than 1.2 g/cm³ and not more than 1.8 g/cm³, and
a hydrogen content in the electron-emitting film is not less than 15 atm % and not more than 40 atm % with respect to the all atoms composing the electron-emitting film.

2. An electron-emitting device according to claim 1,
wherein a concentration of the metal in the range of a depth from a surface of the electron-emitting film up to 10 nm is not less than 0.1 atm % and not more than 40 atm % with respect to number of carbon atoms contained in the electron-emitting film.

3. An electron-emitting device according to claim 1,
wherein the metal is cobalt, platinum, or nickel.

4. An electron-emitting device according to claim 1,
wherein a surface of the electron-emitting film is terminated with hydrogen.

5. An electron source for emitting an electron,
wherein the electron source has the electron-emitting device according to claim 1.

6. An image display apparatus, comprising:
the electron source according to claim 5; and
a light-emitting member.

7. An information display reproducing apparatus, comprising:
the image display apparatus according to claim 6 further having a display unit for displaying an image;
a receiver for outputting at least one information among image information, character information, and sound information included in a received broadcast signal; and
a driving circuit for displaying the information outputted from the receiver on the display unit.
